(19) United States
(12) Patent Application Publication
(10) Pub. No.: US 2012/0266434 A1
(43) Pub. Date: Oct. 25, 2012

(54) METHODS AND APPARATUSES FOR PROTECTING FLEXIBLE (FLEX) CIRCUITS OF OPTICAL TRANSCEIVER MODULES FROM BEING DAMAGED DURING MANUFACTURING AND ASSEMBLY OF THE MODULES

(75) Inventors: Paul Yu, Mountain View, CA (US); Robert Yi, San Jose, CA (US)

(73) Assignee: AVAGO TECHNOLOGIES FIBER IP (SINGAPORE) PTE. LTD., Singapore (SG)

(21) Appl. No.: 13/089,365

(22) Filed: Apr. 19, 2011

(51) Int. Cl. B23P 11/00; G02B 6/12

(52) U.S. Cl. 29/428; 385/14

(57) ABSTRACT

Methods and apparatuses are provided for preventing flex circuits of optical transceiver modules from being damaged during the process of manufacturing and assembling the optical transceiver modules. Preventing the flex circuits from being damaged during the manufacture and assembly processes increases yield and decreases costs. In addition, the methods and apparatuses that are used to prevent the flex circuits from being damaged also allow the processes of forming the mechanical bends and inserting the modules into their respective housings to be automated. Automating these processes further increases yield and decreases costs.

### TECHNICAL FIELD OF THE INVENTION

The invention relates to optical transceiver modules. More particularly, the invention relates to methods and apparatuses for protecting flexible (flex) circuits of optical transceiver modules from being damaged during the manufacture and assembly of the modules.

### BACKGROUND OF THE INVENTION

In optical communications networks, optical transceiver modules are used to transmit and receive optical signals over optical fibers. On the transmit side of an optical transceiver module, a light source (e.g., a laser diode) generates amplitude modulated optical signals that represent data, which are received by an optics system of the transceiver module and directed by the optics system into an end of a transmit optical fiber. The signals are then transmitted over the transmit fiber to a receiver node of the network. On the receive side of the transceiver module, the optics system of the transceiver module receives optical signals output from an end of a receive optical fiber and directs the optical signals onto an optical detector (e.g., a photodiode), which converts the optical signals into electrical signals. The electrical signals are then processed to recover the data contained in the electrical signals.

A variety of different types of optical transceiver modules are in use today in optical communications networks. One type of optical transceiver module is a parallel optical transceiver module. Parallel optical transceiver modules have multiple laser diodes on the transmit side and multiple photodiodes on the receive side for simultaneously transmitting and receiving multiple optical signals. In these types of optical transceiver modules, the transmit fiber cables and the receive fiber cables have multiple transmit and multiple receive optical fibers, respectively. The transmit and receive fiber cables are typically ribbon cables having ends that are terminated in a connector module that is adapted to be plugged into a receptacle of the transceiver module.

Another type of optical transceiver module in use today is a small form factor optical transceiver module. A variety of small form factor optical transceiver modules are in use today. These types of optical transceiver modules have a single laser diode on the transmit side and a single photodiode on the receive side for simultaneously transmitting and receiving optical signals over transmit and receive optical fiber cables, respectively. In these types of optical transceiver modules, transmit and receive receptacles or ports of the modules are adapted to mate with respective ends of the respective transmit and receive optical fiber cables. In some cases, the ends of the optical fiber cables are terminated with connectors (e.g., LC connectors) that are configured to plug into and mate with the receptacles or ports. Alternatively, the ends of the optical fiber cables may be terminated with optical fiber pigtails that are directly secured to the ports of the module.

FIGS. 1A and 1B illustrate a portion 2 of a known small form factor optical transceiver module prior to and subsequent to, respectively, a 90° mechanical bend being formed in the portion 2. The portion 2 includes an optical subassembly (OSA) 3, an electrical subassembly (ESA) 4, a flex circuit 5, and a heat sink 6. The flex circuit 5 has a generally rigid, but yet bendable, structure. With reference first to FIG. 1A, the OSA 3 includes transmit and receive optical ports 3a and 3b, respectively. The transmit and receive optical ports 3a and 3b are designed to mate with ends of transmit and receive optical fiber cables (not shown), respectively. The ESA 4 is a printed circuit board (PCB) having a plurality of electrical connectors 7 disposed on a first end 4a thereof for electrically connecting circuitry of the ESA 4 with electrical circuitry of external equipment (not shown). The flex circuit 5 has a first end 5a that is secured to a second end 4b of the ESA 4 and a second end 5b that is disposed on an upper surface 6a of the heat sink 6.

The OSA 3 is seated on top of the portion of the flex circuit 5 that covers the upper surface 6a of the heat sink 6. The OSA 3 typically includes a laser diode (not shown), a laser diode driver integrated circuit (IC) (not shown), a photodiode (not shown), a receiver IC (not shown), and an optics system (not shown). The electrical and opto-electronic components of the OSA 3 have leads that are connected to electrical conductors of the flex circuit 5, which, in turn, are connected to electrical conductors of the ESA 4.

During operation of the optical transceiver module, heat generated by the electrical and opto-electronic components of the OSA 3 passes through the flex circuit 5 into the heat sink 6, which is made of a material having a high thermal conductivity (e.g., copper). The heat that enters the heat sink 6 spreads out and is at least partially dissipated.

One of the benefits of the design shown in FIG. 1A is that a highly automated process may be performed at the panel level to mount a large number of the OSA 3 on respective heat sinks 6 of respective portions 2 of respective optical transceiver modules. During the mounting process, high-precision placement machines pick up the OSAs 3, place them on the portions of the flex circuits 5 that cover the heat sinks 6, and secure the OSAs 3 in position. After the mounting process has been performed, the panel is singulated into the individual portions 2 shown in FIG. 1A.

One problem that sometimes occurs during the mounting process is that the flex circuits 5 may be damaged. The OSAs 3 are relatively heavy and therefore exert a relatively large force on the flex circuits 5 when they are mounted thereon. Consequently, if both the ESA 4 and the heat sink 6 are not properly supported during the mounting process, the flex circuits 5 can be damaged. In addition, the flex circuits 5 may also be damaged during the mechanical bend process, as will now be described with reference to FIG. 1B.

With reference to FIG. 1B, before the portions 2 are placed in their respective module housings (not shown), a 90° mechanical bend is formed in the flex circuit 5 to place the portion in a permanently bent state. The mechanical bend process places stress on the rigid flex circuit 5. If both the ESA 4 and the heat sink 6 are not properly supported during the bend process, the stress placed on the flex circuit 5 can cause it to break, thereby decreasing yield and increasing costs. In addition, the flex circuit 5 has a minimum bend radius. If the minimum bend radius is exceeded during the bend process, damage to the flex circuit 5 can occur. Therefore, great care must be taken during the bend process to ensure that the flex circuit 5 is not bent beyond its minimum bend radius. The bend process is typically performed manually. After the bend has been formed, the portion 2 is manually inserted into the respective module housing (not shown). These manual processes are prone to human error and decrease the speed at which the overall assembly process can be performed, which further decreases yield and increases manufacturing costs.

Accordingly, a need exists for ways to prevent the flex circuits 5 from being damaged during the manufacturing and assembly processes. A need also exists for ways to automate the processes of forming the mechanical bends and inserting the portions 2 into their respective module housings while also ensuring that the flex circuits 5 remain undamaged during these processes.

### SUMMARY OF THE INVENTION

The invention provides methods and apparatuses for preventing a flex circuit of an optical transceiver module from being damaged during the manufacture and assembly of the module. The apparatus comprises a structural support mechanically coupled on a first end thereof to a PCB of an ESA of the optical transceiver module and mechanically coupled on a second end thereof to a heat sink of the optical transceiver module. The flex circuit is mechanically coupled on a first end thereof to the PCB and on a second end thereof to the heat sink. The structural support provides strain relief for the flex circuit.

The method, in accordance with an illustrative embodiment, comprises providing an optical transceiver module comprising an ESA, a heat sink, a flex circuit, and an OSA, providing a structural support having at least a first end that is mechanically coupled to a second end of a PCB of the ESA and having a second end mechanically coupled to the heat sink, and performing a mechanical bend process to bend a portion of the optical transceiver module such that the OSA is rotated through an angle of approximately 90 degrees relative to the PCB.

The method, in accordance with an illustrative embodiment, comprises providing an optical transceiver module comprising an ESA, a heat sink, a flex circuit, and an OSA, performing a mechanical bend process to bend a portion of the optical transceiver module by an angle of approximately 90 degrees relative to the PCB of the ESA to place the optical transceiver module in a bent state, and providing a structural support that maintains the optical transceiver module in the bent state. The structural support provides strain relief for the flex circuit.

These and other features and advantages of the invention will become apparent from the following description, drawings and claims.

### BRIEF DESCRIPTION OF THE DRAWINGS

FIGS. 1A and 1B illustrate a portion of a known optical transceiver module prior to and subsequent to, respectively, a 90° mechanical bend being formed therein.

FIG. 2 illustrates a perspective bottom view of the portion of the optical transceiver module shown in FIGS. 1A and 1B having the apparatus in accordance with an illustrative embodiment secured thereto.

FIGS. 3A-3E illustrate side views of the portion of the optical transceiver module shown in FIG. 2 at various stages of the mechanical bend process.

FIGS. 4A and 4B illustrate bottom perspective views of the portion of the optical transceiver module shown in FIGS. 1A and 1B in unbent and bent states, respectively, and having an apparatus in accordance with another illustrative embodiment secured thereto for protecting the flex circuit.

FIGS. 5A and 5B illustrate bottom perspective views of the portion of the optical transceiver module shown in FIGS. 1A and 1B in the bent and unbent states, respectively, and having an apparatus in accordance with another illustrative embodiment secured thereto for protecting the flex circuit.

FIG. 6 illustrates a bottom perspective view of the portion of the optical transceiver module shown in FIGS. 1A and 1B in accordance with another illustrative embodiment in which an over-molding process is used to fix the portion in the bent state and to protect the flex circuit.

### DETAILED DESCRIPTION OF AN ILLUSTRATIVE EMBODIMENT

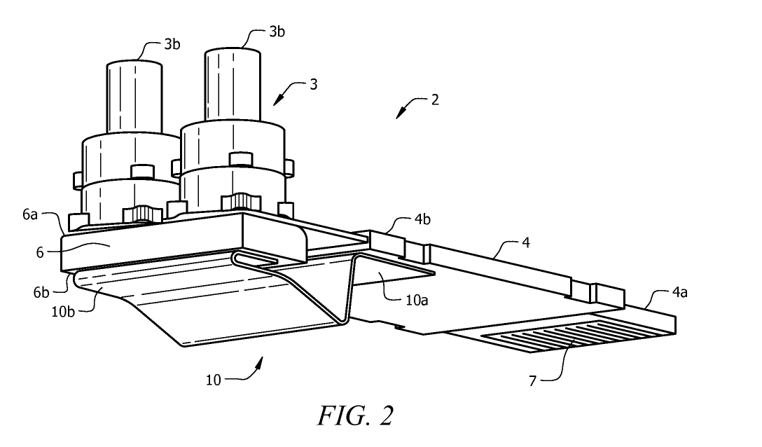

In accordance with various embodiments described herein, methods and apparatuses are provided for preventing flex circuits of optical transceiver modules from being damaged during the process of manufacturing and assembling the optical transceiver modules. Preventing the flex circuits from being damaged during the manufacture and assembly processes increases yield and decreases costs. In addition, the methods and apparatuses that are used to prevent the flex circuits from being damaged also allow the processes of forming the mechanical bends and inserting the modules into their respective housings to be automated. Automating these processes further increases yield and decreases costs. Exemplary, or illustrative, embodiments of the invention will now be described with reference to FIGS. 2-6.

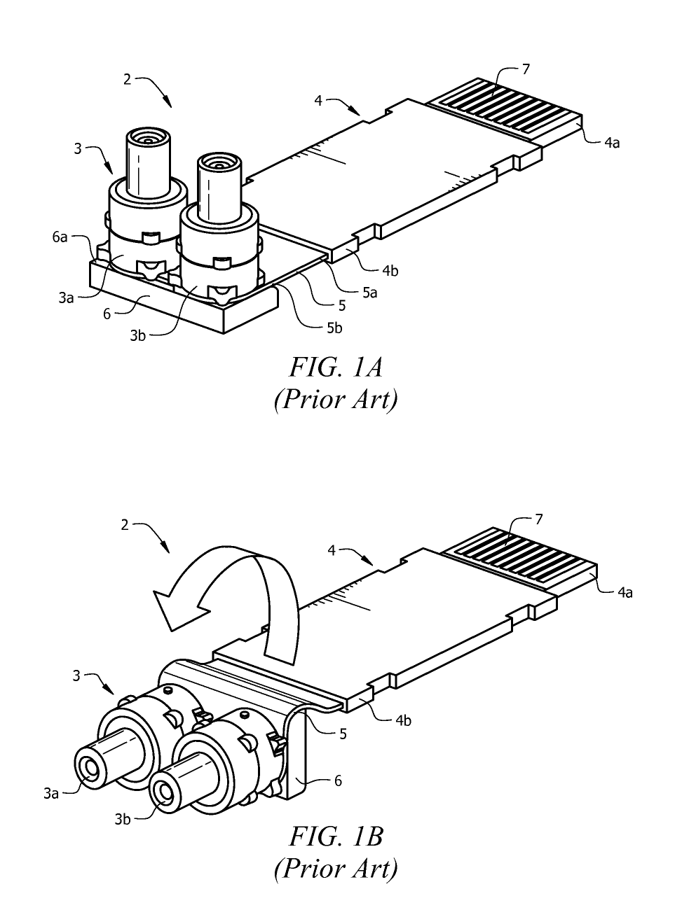

The apparatus and method are not limited to being used with any particular type of optical transceiver module, but for ease of illustration and discussion, it will be assumed for exemplary purposes that the apparatus and method are used with the portion 2 of the optical transceiver module shown in FIGS. 1A and 1B. Therefore, like reference numerals in FIGS. 1A-6 represent like components. As will be described below in detail, the apparatus is a generally rigid structural support that provides strain relief for the flex circuit 5 and prevents the flex circuit from being damaged during the manufacture and assembly of the optical transceiver module. In some embodiments, the structural support is deformable, or bendable, such that it can be placed in a permanently bent shape, or state. In other embodiments, the structural support includes features that enable it to be rotated or hinged in order to place the portion 2 in the permanently bent state. In still other embodiments, the apparatus is secured to the portion 2 after the portion 2 has been placed in the permanently bent state. Because the structural support may be configured in virtually an infinite number of ways, the structural support is described herein with reference to a few illustrative, or exemplary, embodiments. It will be understood by persons skilled in the art that the structural support is not limited to the embodiments described herein.

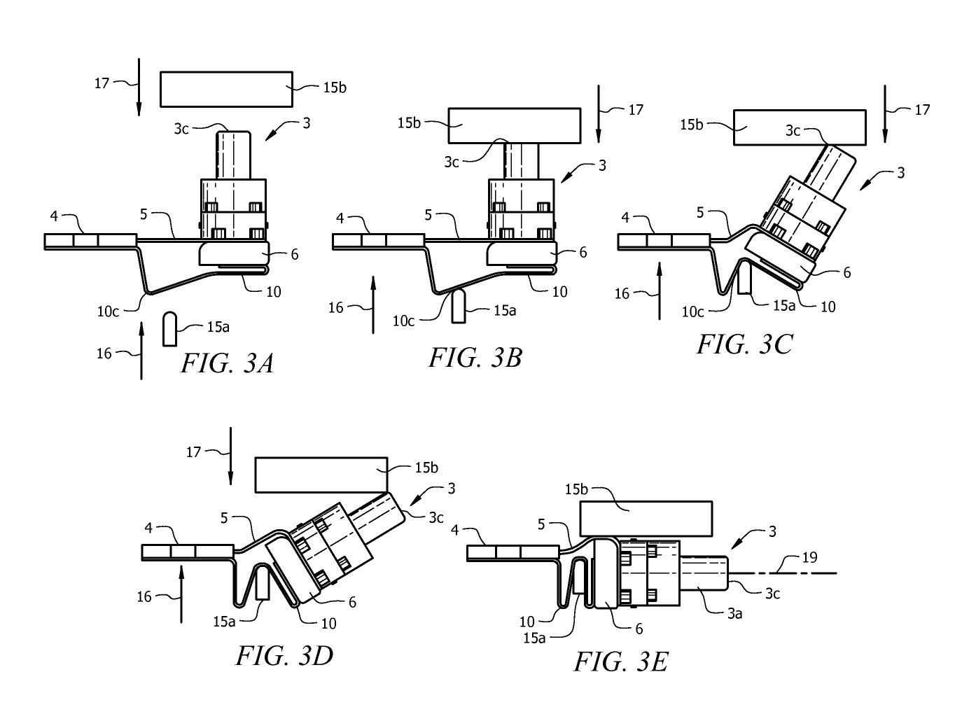

FIG. 2 illustrates a perspective bottom view of the portion 2 of the optical transceiver module shown in FIGS. 1A and 1B having an apparatus 10 in accordance with an illustrative embodiment secured thereto. In accordance with this illustrative embodiment, the apparatus 10 is a leadframe. The leadframe 10 has a first end 10a that is secured to the second end 4b of the ESA 4 and a second end 10b that is secured to a lower surface 6b of the heat sink 6. The leadframe 10 has a generally rigid, but yet bendable, structure, and is typically made of a metallic material. The leadframe 10 may be secured to the PCB of the ESA 4 and to the lower surface 6b of the heat sink 6 during the process of populating the PCB of the ESA 4. Because the leadframe 10 has a generally rigid structure, the leadframe 10 functions as a strain relief mechanism for the flex circuit 5 by providing support at both the ESA 4 and at the heat sink 6. This strain relief mechanism prevents the flex circuit 5 from being damaged during the process of placing the OSA 3 on the portion of the upper surface 6a of the heat sink 6 that is covered with the second end 5b of the flex circuit 4. In addition, the leadframe 10 has a configuration that is designed to provide strain relief during the mechanical bend process to prevent the flex circuit 5 from being damaged during the mechanical bend process, as will now be described with reference to FIGS. 3A-3E.

FIGS. 3A-3E illustrate side views of the portion 2 of the optical transceiver module shown in FIG. 2 at various stages of the mechanical bend process. In accordance with this illustrative embodiment, a mandrel 15 comprising a nose piece 15a and a press 15b is used to perform the mechanical bend process. The portion 2 is moved into a work position between the nose piece 15a and the press 15b, as shown in FIG. 3A. In the work position, the nose piece 15a is positioned beneath a portion 10c of the leadframe 10 and the press 15b is positioned above an end 3c of the OSA 3. The nose piece 15a and the press 15b are then moved in the directions of arrows 16 and 17, respectively, into contact with the portion 10c and end 3c, respectively, as shown in FIG. 3B. With the press 15b held in the position shown in FIG. 3B, the nose piece 15a is moved farther in the direction indicated by arrow 16, i.e., toward the press 15b. This additional movement of the nose piece 15a causes the leadframe 10 to bend at portion 10c, as shown in FIG. 3C. The press 15b is then moved farther in the direction indicated by arrow 17, i.e., toward the nose piece 15a. This additional movement of the press 15b causes the bend in the leadframe 10 at portion 10c to increase, as shown in FIG. 3D. As movement of the press 15b continues in this direction, the bend at portion 10c further increases until the leadframe 10 has the shape shown in FIG. 3E. At this point, a permanent 90° mechanical bend has been formed in the portion 2 and the bend process is complete. In the permanently bent state shown in FIG. 3E, the optical axes 19 of the transmit and receive optical ports 3a and 3b of the OSA 3 are parallel to the plane of the PCB of the ESA 4.

One of the primary advantages of the method described above with reference to FIGS. 3A-3E is that the leadframe 10 provides strain relief that will prevent the flex circuit 5 from being damaged during the process of mounting the OSAs 3. Another advantage is that the shape of the leadframe 10 once it has been deformed to the permanently bent state ensures that the flex circuit 5 will not be bent beyond its minimum bend radius. This latter feature helps ensure that the flex circuit will not be damaged during the mechanical bend process and that the OSA 3 is in the proper orientation for insertion of the module comprising portion 2 into its module housing (not shown). The strain relief provided by the leadframe 10 also helps ensure that the flex circuit 5 will not be damaged during the mechanical bend process. All of these features help increase yield and decrease costs. Yet another advantage is that the processes of moving the portion 2 into the work position shown in FIG. 3A and using the mandrel 15 to form the mechanical bend as shown in FIGS. 3B-3E are well suited for automation. Yet another advantage is that automating these processes further facilitates automation of the subsequent process of inserting the portion 2 into its respective module housing (not shown). By automating these processes rather than performing them manually, the processes can be performed faster and with a lower potential for error, thereby further increasing yield and decreasing costs.

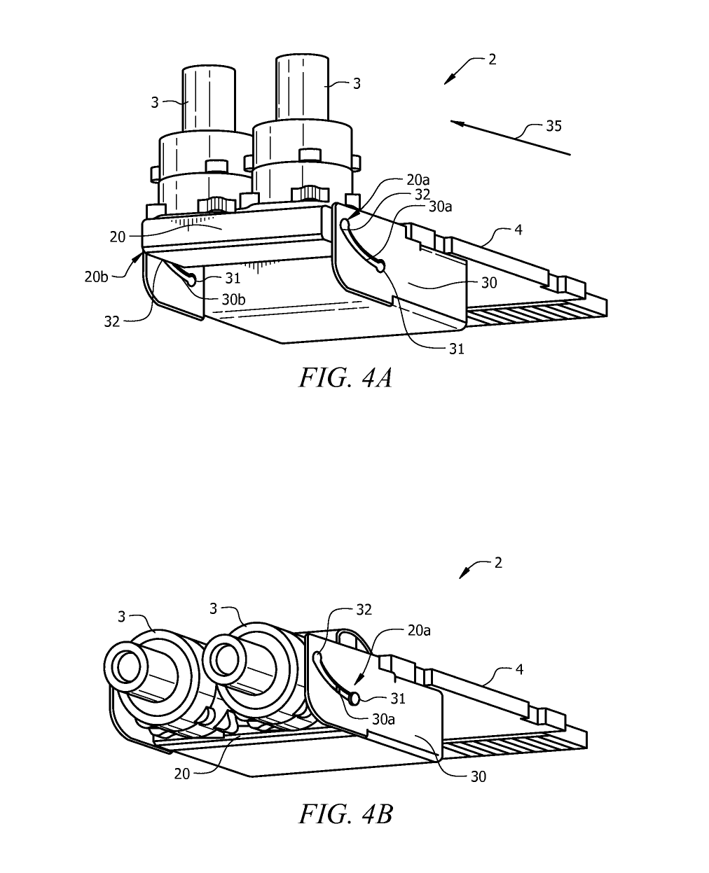

FIGS. 4A and 4B illustrate bottom perspective views of the portion of the optical transceiver module shown in FIGS. 1A and 1B in unbent and permanently bent states, respectively, and having an apparatus in accordance with another illustrative embodiment secured thereto for protecting the flex circuit 5. In accordance with this illustrative embodiment, the apparatus comprises portions of a heat sink 20 and portion of a leadframe 30 that mechanically couple with one another. The heat sink 20 and leadframe 30 are different from the heat sink 6 and leadframe 10, respectively, shown in FIGS. 2 and 3A-3E. In accordance with this illustrative embodiment, the leadframe 30 has arcuately-shaped slots 30a and 30b formed in opposite sides thereof, and the heat sink 20 has pins 20a and 20b formed in opposite sides thereof. The pins 20a and 20b engage (ride within) the slots 30a and 30b, respectively. The slots 30a and 30b have lower ends 31 and upper ends 32. When the pins 20a and 20b are in abutment with the upper ends 32 of the slots 30a and 30b, the portion 2 is in the unbent state, i.e., it does not have the 90° mechanical bend formed in it. When a force is applied in the direction of arrow 35 against the OSA 3, the pins 20a and 20b move along the slots 30a and 30b, respectively, until the pins 20a and 20b are in abutment with the lower ends 31 of the slots 30a and 30b. At this pint, the portion 2 is in the 90° permanently-bent state shown in FIG. 4B.

When the portion 2 is in the unbent state shown in FIG. 4A, the leadframe 20 provides strain relief for the flex circuit 5 that prevents the flex circuit 5 from being damaged during the mounting of the OSA 3. As the portion 2 is moved from the unbent state shown in FIG. 4A to the permanently bent state shown in FIG. 4B, the slots 20a and 20b in the leadframe 20 control the bend process and prevent the portion 2 from being bent to an angle that is less than 90°. This latter feature ensures that the flex circuit 5 will not be bent beyond its minimum bend radius and that the OSA 3 is in the proper orientation for insertion of the module comprising portion 2 into its module housing (not shown).

The leadframe 20 shown in FIGS. 4A and 4B may be attached to the portion 2 during the automated process of populating the PCB of the ESA 4. The process of forming the mechanical bend described above with reference to FIGS. 4A and 4B can also be automated. As indicated above, automating the mechanical bend process allows the process to be performed faster and with a decreased chance of error, which helps increase yield and decrease costs. In addition, as indicated above, automation of the mechanical bend process facilitates automation of the process of inserting the portion 2 into its respective module housing (not shown).

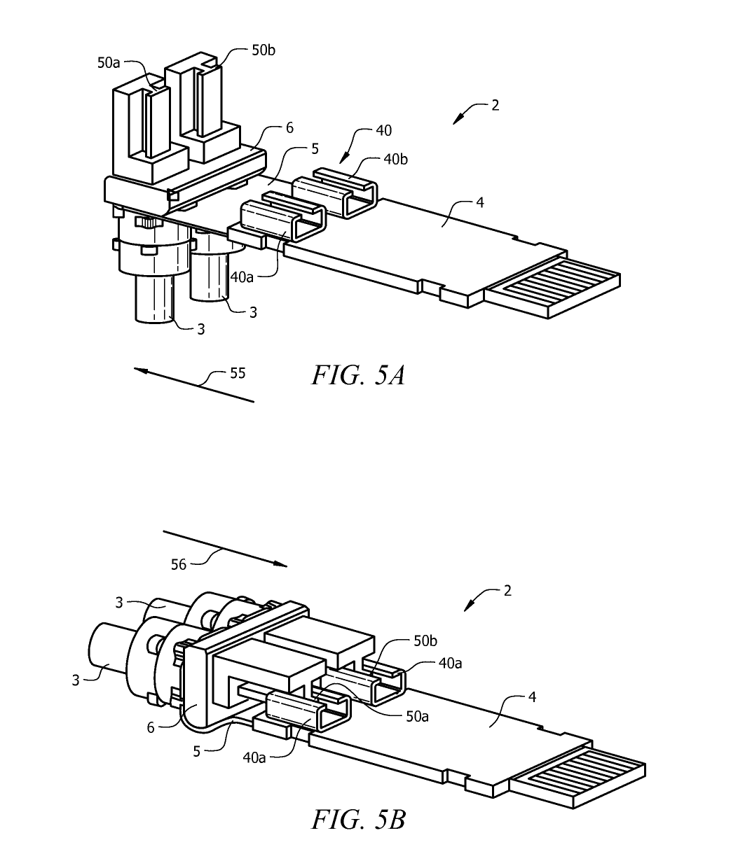

FIGS. 5A and 5B illustrate bottom perspective views of the portion 2 of the optical transceiver module in the bent and unbent states, respectively, in accordance with another illustrative embodiment. In accordance with this embodiment, the leadframe 40 has tracks 40a and 40b formed therein and the heat sink 6 has rails 50a and 50b secured thereto. In accordance with this embodiment, the heat sink 6 is identical to the heat sink shown in FIGS. 1A- 3E. The rails 50a and 50b are made of a plastic material and are formed by a known over-molding technique. The tracks 40a and 40b are shaped to receive the rails 50a and 50b, respectively, in an interlocking relationship. In order to cause the tracks 40a and 40b to engage the rails 50a and 50b, respectively, a force in the direction of arrow 55 is applied against the OSA 3. The application of this force causes the OSA 3 to rotate from the unbent position shown in FIG. 5A into the permanently bent position shown in FIG. 5B. A force is then applied against the OSA 3 in the direction indicated by arrow 56 to cause the rails 50a and 50b to engage the tracks 40a and 40b, respectively, in the interlocking relationship. The interlocking engagement of the rails 50a and 50b with the tracks 40a and 40b, respectively, ensures that the flex circuit 5 will not be bent beyond its minimum bend radius and that the OSA 3 is in the proper orientation for insertion of the module comprising portion 2 into its module housing (not shown).

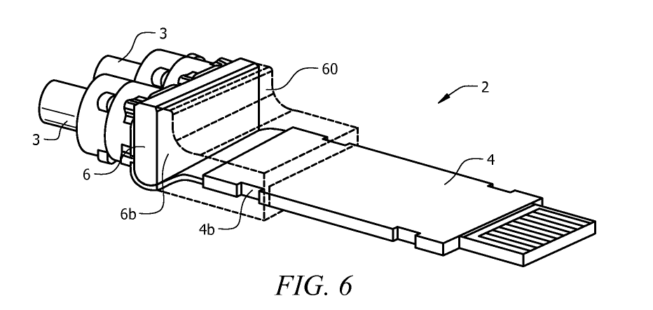

FIG. 6 illustrates a bottom perspective view of the portion 2 of the optical transceiver module in accordance with another illustrative embodiment in which an over-molding process is used to fix the portion 2 in the 90° bent state and protect the flex circuit 5. The portion 2 may be bent using a manual or automated process to place it in the bent state shown in FIG. 6. After the portion 2 has been placed in the bent state shown in FIG. 6, a known over-molding process is used to encapsulate portions of the lower surface 6b of the heat sink 6, the flex circuit 5 and the end 4b of the ESA 4 inside of a plastic over-mold 60. The plastic over-mold 60 secures the portion 2 in the permanently-bent state shown in FIG. 6 to prevent the flex circuit 5 from being bent beyond its minimum bend radius. The over-mold 60 also ensures that OSA 3 is in the proper orientation for insertion of the module comprising portion 2 into its module housing (not shown). This latter feature facilitates automation of the process of inserting the portion 2 into its respective module housing (not shown).

It can be seen from the illustrative embodiments described above with reference to FIGS. 2- 6 that a variety of apparatuses and methods may be used to perform the mechanical bend process and to protect the flex circuit 5 from being damaged during the mechanical bend process and during other processes that occur during the manufacture and assembly of the optical transceiver module. These features of the invention increase yield and decrease costs. In addition, as indicated above, the invention enables the methods of forming the mechanical bend and of inserting the portion 2 into its respective module housing (not shown) to be automated, which also increase yield and decreases costs. Persons skilled in the art will understand, however, that the invention is not limited to the exemplary embodiments described herein.

It should be noted that the invention has been described above with reference to a few illustrative. Or exemplary, embodiments for the purposes of demonstrating the principles and concepts of the invention. Those skilled in the art will understand that many modifications may be made to the embodiments described herein and that all such modifications are within the scope of the invention. For example, while the invention has been described with reference to the portion 2 of a known optical transceiver module, the invention is not limited to this particular configuration. It should also be noted that the term “optical transceiver module”, as that term is used herein, refers to an optical receiver module, an optical transmitter module or an optical transceiver module.

What is claimed is:

1. An apparatus for protecting a flexible (flex) circuit of an optical transceiver module, the apparatus comprising:
a structural support having at least a first end and a second end, the structural support being mechanically coupled on the first end thereof to a printed circuit board (PCB) of an electrical subassembly (ESA) of the optical transceiver module, the structural support being mechanically coupled on the second end thereof to a heat sink of the optical transceiver module, the flex circuit being mechanically coupled on a first end thereof to the PCB and on a second end thereof to the heat sink, and wherein the structural support provides strain relief for the flex circuit.

2. The apparatus of claim 1, wherein the apparatus comprises a metal leadframe, and wherein the leadframe is designed to be bent by an angle of approximately 90 degrees into a permanently bent state, and wherein when the leadframe is in the permanently bent state, a bend is formed in the flex circuit, and wherein the strain relief provided by the leadframe to the flex circuit when the leadframe is in the permanently bent state ensures that the bend in the flex circuit has a radius that is less than or equal to a minimum bend radius of the flex circuit.

3. The apparatus of claim 1, wherein the apparatus comprises a metal leadframe, the leadframe being mechanically coupled to the heat sink in a way that allows the heat sink to rotate relative to the PCB through an angular range comprising angles ranging from approximately 0 degrees to approximately 90 degrees, and wherein when the heat sink has been rotated by approximately 90 degrees relative to the PCB, a bend is formed in the flex circuit that has a minimum bend radius that is less than or equal to a minimum bend radius of the flex circuit.

4. The apparatus of claim 3, wherein the leadframe and the heat sink are mechanically coupled to each other by first and second pins disposed on opposite sides of the heat sink that are received in first and second slots, respectively, formed in opposite sides of the leadframe, wherein the first and second pins are confined to move within the first and second slots, respectively, to thereby confine the rotation of the heat sink to said angular range.

5. The apparatus of claim 1, wherein the structural support is a generally rigid plastic material having a permanent angle of approximately 90 degrees formed therein, wherein the approximately 90-degree angle formed in the plastic over-molded support structure ensures that a bend formed in the flex circuit has a radius that is less than or equal to a minimum bend radius of the flex circuit.

6. The apparatus of claim 5, wherein the plastic structural support is an over-molded plastic part.

7. The apparatus of claim 1, wherein the apparatus comprises a metal leadframe, the leadframe having interlocking features that are adapted to interlock with interlocking features secured to a lower surface of the heat sink, wherein when the interlocking features of the leadframe are interlocked with the interlocking features secured to the heat sink, the lower surface of the heat sink is at an angle of approximately 90 degrees to the PCB and a bend is formed in the flex circuit that has a minimum bend radius that is less than or equal to a minimum bend radius of the flex circuit.

8. The apparatus of claim 7, wherein the interlocking features secured to the lower surface of the heat sink are first and second rails, and wherein the interlocking features of the leadframe are first and second tracks, the first and second tracks and the first and second rails being adapted to interlock with one another, respectively.

9. The apparatus of claim 7, wherein the first and second rails are plastic over-molded rails.

10. A method for protecting a flexible (flex) circuit of an optical transceiver module from damage, the method comprising:
providing an optical transceiver module comprising an electrical subassembly (ESA), a heat sink, a flex circuit, and an optical subassembly (OSA), the ESA having a printed circuit board (PCB) having a first end and a second end, the flex circuit having a first end secured to the second end of the PCB and having a second end secured to the heat sink, the OSA being mechanically coupled to the heat sink;
providing a structural support having at least a first end and a second end, the first end of the structural support being mechanically coupled to the second end of the PCB, the second end of the structural support being mechanically coupled to the heat sink, and wherein the structural support provides strain relief for the flex circuit; and
performing a mechanical bend process to bend a portion of the optical transceiver module such that the OSA is rotated through an angle of approximately 90 degrees relative to the PCB.

11. The method of claim 10, wherein the structural support comprises a metal leadframe, and wherein the leadframe is designed to be bent by an angle of approximately 90 degrees into a permanently bent state, wherein the mechanical bend process is performed by bending the leadframe such that the leadframe is placed in a permanently bent state, wherein when the leadframe is placed in the permanently bent state, a bend is formed in the flex circuit, and wherein the strain relief provided by the leadframe to the flex circuit when the leadframe is in the permanently bent state ensures that the bend in the flex circuit has a radius that is less than or equal to a minimum bend radius of the flex circuit.

12. The method of claim 10, wherein the structural support comprises a metal leadframe, the leadframe being mechanically coupled to the heat sink in a way that allows the heat sink to rotate relative to the PCB through an angular range comprising angles ranging from approximately 0 degrees to approximately 90 degrees, wherein the mechanical bend process is performed by rotating the heat sink by approximately 90 degrees relative to the leadframe, wherein when the heat sink is rotated by approximately 90 degrees relative to the leadframe, a bend is formed in the flex circuit that has a minimum bend radius that is less than or equal to a minimum bend radius of the flex circuit.

13. The method of claim 12, wherein the leadframe and the heat sink are mechanically coupled to each other by first and second pins disposed on opposite sides of the heat sink that are received in first and second slots, respectively, formed in opposite sides of the leadframe, wherein the first and second pins are confined to move within the first and second slots, respectively, to confine the heat sink to rotation over the angular range.

14. The method of claim 10, wherein the structural support comprises a metal leadframe, the leadframe having interlocking features that are adapted to interlock with interlocking features secured to a lower surface of the heat sink, wherein the mechanical bend process comprises interlocking the interlocking features of the leadframe with the interlocking features secured to the heat sink such that the lower surface of the heat sink is at an angle of approximately 90 degrees to the PCB and a bend is formed in the flex circuit that has a minimum bend radius that is less than or equal to a minimum bend radius of the flex circuit.

15. The method of claim 14, wherein the interlocking features secured to the lower surface of the heat sink are first and second rails, and wherein the interlocking features of the leadframe are first and second tracks, the first and second tracks and the first and second rails being adapted to interlock with one another, respectively.

16. The method of claim 15, wherein the first and second rails are plastic over-molded rails.

17. The method of claim 10, wherein the mechanical bend process is an automated process performed by one or more machines.

18. A method for protecting a flexible (flex) circuit of an optical transceiver module from damage, the method comprising:
providing an optical transceiver module comprising an electrical subassembly (ESA), a heat sink, a flex circuit, and an optical subassembly (OSA), the ESA having a printed circuit board (PCB) having a first end and a second end, the flex circuit having a first end secured to the second end of the PCB and having a second end secured to the heat sink, the OSA being mechanically coupled to the heat sink;
performing a mechanical bend process to bend a portion of the optical transceiver module by an angle of approximately 90 degrees relative to the PCB to place the optical transceiver module in a bent state; and
providing a structural support having at least a first end and a second end, the first end of the structural support being mechanically coupled to the second end of the PCB, the second end of the structural support being mechanically coupled to the heat sink, and wherein the structural support maintains the optical transceiver module in the bent state and provides strain relief for the flex circuit.

19. The method of claim 18, wherein the structural support comprises a plastic material that encases portions of the second end of the PCB, the heat sink and the flex circuit, wherein the structural support has a permanent angle of approximately 90 degrees formed therein that ensures that a bend formed in the flex circuit during the mechanical bend process has a radius that is less than or equal to a minimum bend radius of the flex circuit.

20. The method of claim 19, wherein the generally rigid plastic material comprising the structural support is formed via a plastic over-molding process.

21. The method of claim 18, wherein the mechanical bend process is an automated process performed by one or more machines.
